(19) United States
(12) Patent Application Publication
(10) Pub. No.: US 2022/0255360 A1
(43) Pub. Date: Aug. 11, 2022

(54) BATTERY MODULE CONFIGURED TO ENABLE SMART RINGS OF VARIOUS SIZES TO HAVE RADIO-FREQUENCY WIRELESS CHARGING CAPABILITIES, AND A WIRELESS CHARGER DEVICE TO WIRELESSLY DELIVER POWER TO THE SMART RINGS

(71) Applicant: Energous Corporation, San Jose, CA (US)

(72) Inventors: Sohini SENGUPTA, Milpitas, CA (US); Kishore RAMACHANDRAMURTHY, San Jose, CA (US); Yunhong LIU, San Jose, CA (US); Chris GRIGOREAN, Fremont, CA (US)

(21) Appl. No.: 17/668,732

(22) Filed: Feb. 10, 2022

Related U.S. Application Data
(60) Provisional application No. 63/160,593, filed on Mar. 12, 2021.
(60) Provisional application No. 63/148,096, filed on Feb. 10, 2021.

(51) Int. Cl. H02J 50/23; H01Q 7/00; H01Q 9/04; H02J 50/00; H02J 50/27; H02J 50/40; H02J 7/00

(52) U.S. Cl. CPC H02J 50/23; H01Q 7/00; H01Q 9/0421; H02J 7/0044; H02J 50/27; H02J 50/402; H02J 7/0013; H02J 50/005

(57) ABSTRACT

An example transmitter comprises a housing with a top surface that allows for placement of a ring device to be wirelessly charged by the transmitter, the ring device is a device that is capable of receiving a power from the transmitter. An antenna, placed inside of the housing and disposed below the top surface, configured to transmit radio frequency (“RF”) waves to the ring device, where a radiator of the antenna has a circular shape that is positioned coplanar with the inner surface of the housing and the radiator has a certain thickness that is defined by an inner radiator diameter and an outer radiator diameter; and the inner radiator diameter of the radiator is substantially equal to the first inner ring diameter of the smallest ring device, and the outer radiator diameter of the radiator is substantially equal to the first outer ring diameter of the largest ring device.

### RELATED APPLICATIONS

This application claims priority to U.S. Provisional Patent Application Ser. No. 63/160,593, filed on Mar. 12, 2021 entitled “Battery Module Configured to Enable Smart Rings of Various Sizes to Have RF Wireless Charging Capability, And A Wireless Charger Device to Wirelessly Deliver Power to The Smart Rings,” and U.S. Provisional Patent Application Ser. No. 63/148,096, filed on Feb. 10, 2021 entitled “Battery Module Configured to Enable Smart Rings of Various Sizes to Have RF Wireless Charging Capability, And A Wireless Charger Device to Wirelessly Deliver Power to The Smart Rings,” each of which is incorporated by reference herein in its respective entirety.

### TECHNICAL FIELD

The present disclosure relates generally to wireless power transmission, and more particularly to radiating antennas configured to charge wearable ring devices (e.g., smart rings that contain at least one sensor) of varying sizes (e.g., sizes to accommodate different sized fingers) that are placed in varying orientations on a charging surface without sacrificing charging efficiency when the rings are placed at the varying orientations on the charging surface.

### BACKGROUND

Wearable ring devices, such as smart rings, have been gaining in popularity as they are able to contain various sensors for monitoring biometric information and physical activity in a small form factor. Wearable ring devices, unlike watches, are not easily adjusted to accommodate different finger sizes of each user. This results in numerous sizes and models of wearable ring devices needing to be produced (e.g., a different wearable ring device for each standard finger size). As a result of these various sizes, there is a need for numerous charging components tailored to each ring size and numerous internal components (e.g., size specific batteries, PCBs, and sensors) to accommodate different ring sizes. These conventional methods result in increased research and development costs to design all of these different sized components. In addition, there is also an increased production and tooling cost associated with each additional variation.

Additionally, having size-specific charging components forces a user to charge their device only on the supplied charger that came with the wearable ring device. This limits how easily a user can recharge their device. For example, it may be very difficult for a user to charge their wearable ring device when they find themselves away from the supplied charger. In addition to charging constraints for end-users, the use of a specific charger for a specific ring size also can cause problems for manufacturers by requiring the manufacturers to manufacture size-specific chargers for different ring sizes, which can increase production costs.

### SUMMARY

Accordingly, there is a need for a near-field charging system that addresses the problems identified above. To this end, systems and methods described herein are capable of allowing easy and convenient wireless charging of wearable ring devices on a charging surface and of providing battery modules that enable wireless charging for smart rings of many various sizes, which allows users more flexibility to place their devices to be charged at various positions on the charging surface and enables use of the battery module in many different rings, without having to design different battery modules for each size of ring.

(A1) In some embodiments, a transmitter system for wireless power transmission is provided, the system comprises a housing (e.g., made of a material that allows for the transmission of radio frequency waves) that includes a top surface (e.g., top housing 114 in FIGS. 1, 2A, and 2B) that allows for placement of one of a plurality of wearable ring devices (e.g., the wearable ring device 102 in FIG. 1, wearable ring device 204 in FIG. 2A, and wearable ring device 212 in FIG. 2B) to be wirelessly charged by the transmitter system (e.g., near-field charging system 100), the plurality of wearable ring devices being those wearable ring devices that are capable of receiving a wireless charge from the transmitter system. The plurality of wearable ring devices include: a smallest wearable ring device having a first inner ring diameter that is smaller than or equal to respective inner ring diameters for all other of the plurality of wearable ring devices (e.g., first top view 108 in FIG. 1 illustrates that the inner diameter of the depression 116, indicated by ‘A’ 118 in the first top-down view 108 is undersized by 5% relative to the smallest supported inner diameter of a wearable ring device, indicated by ‘B’ 120), and a largest wearable ring device having a first outer ring diameter that is larger than or equal to respective outer ring diameters for all other of the plurality of wearable ring devices; (e.g., second top view 110 in FIG. 1 illustrates that the outer diameter of the depression 116, indicated by ‘D’ 124 in the first top-down view 108 is oversized by 5% relative to the largest supported outer diameter of a wearable ring device, indicated by ‘C’ 122. In some embodiments, the outer diameter of the depression 116, indicated by ‘D’ 124 in the first top-down view 108 is oversized by a 1%-10% relative to the largest supported outer diameter of a wearable ring device. For example, the outer diameter may be oversized to accommodate a sensor or embellishment (e.g., a gemstone place on the outer diameter) that exceeds the outer diameter of the wearable ring device. In some embodiments, the wearable ring is worn on a user's digit (finger or toe) and also includes at least one electronic sensor for monitoring data associated with a human user, which can be biometric data and/or data associated with physical activities of the user such as number of steps).

In some embodiments, the transmitter system also comprises an antenna (e.g., FIGS. 2A and 2B show an antenna that includes a radiator 202), and the antenna is disposed below the top surface (or integrated within the top surface of the housing) (e.g., a top housing 114 in FIGS. 1, 2A, and 2B), configured to transmit power in the form of radio frequency (“RF”) electromagnetic waves to the wearable ring device (e.g., a circularly-shaped device capable of being placed around a digit of an individual). In FIGS. 2A-2B, a top surface of radiator 202 is shown, but one of skill in this art will appreciate that the radiator 202 includes components of: a top conductor (shown in the figure), an underside of the top conductor (not shown), and a conductor portion coupled to the ground plane for the antenna 210. The discussion herein of features of the radiator 202 refers to features for the top conductor portion of the radiator 202 unless the description specifically indicates otherwise. In the descriptions provided herein, RF electromagnetic power waves are also referred to as electromagnetic power waves, radio-frequency power waves, or simply as power waves, which terms are thus used interchangeably in the descriptions provided herein. In some embodiments, the wearable ring device is made of a non-conductive material to allow the transmission of RF electromagnetic waves to the antenna.

In some embodiments, radiator 202 of the antenna within the transmitter system has a circular shape (e.g., the antenna follows a circular path that corresponds to the circular shape of a ring placed on a flat surface) that is positioned under the top surface or flush (or coplanar) with the top surface, and the radiator has a certain thickness (e.g., a width) that is defined by an inner radiator diameter (e.g., inner radiator diameter 206 in FIGS. 2A-2B) and an outer radiator diameter (e.g., outer radiator diameter 208 in FIGS. 2A-2B). In one example, FIGS. 2A and 2B show an antenna that includes a radiator 202 with a certain thickness that allows for the radiator 202 to transmit RF power through electromagnetic waves to numerous wearable ring devices of various sizes (e.g., wearable ring device 204 and wearable ring device 212). In some embodiments, the inner radiator diameter of the radiator is substantially equal to the first inner ring diameter of the smallest wearable ring device (e.g., within at least 5% of the first inner ring diameter of the smallest wearable ring device, which can be a 10 mm inner diameter so the inner radiator diameter would then be about 9.5 mm), and the outer radiator diameter of the radiator is substantially equal to the first outer ring diameter of the largest wearable ring device (e.g., a 25 mm outer diameter) (e.g., again, FIGS. 2A and 2B show an antenna that includes a radiator 202 with a certain thickness that allows for the radiator 202 to wirelessly transmit power to numerous wearable ring devices of various sizes (e.g., wearable ring device 204 and wearable ring device 212)).

In some embodiments, the transmitter system is further configured to determine whether a respective wearable ring device of the plurality of wearable ring devices is placed on the top surface of the housing (e.g., this determination is performed by either detecting an impedance mismatch, a Bluetooth connection, a Wi-Fi connection, a ZigBee connection, or any other suitable communications protocol). In response to determining that the respective wearable ring device being placed on the top surface of the housing, the wireless delivery of power through the transmission of electromagnetic waves to the respective wearable ring device begins.

(A2) In some embodiments of (A1), a first wearable ring device has a first size (e.g., this size can correspond to an International Organization for Standardization (“ISO”) 8653:2016 ring size), and when the first wearable ring device is placed on the top surface of the housing, a first amount of power is received at the first wearable ring device based on power through the transmission of electromagnetic transmitted by the transmitter system to the first wearable ring device (e.g., FIG. 2A shows wearable ring device 204 that has a first size and receives a first amount of power). In some embodiments, the first amount of power is an amount of power that is capable of charging a power source of the first wearable ring device and/or is capable of directly powering the first wearable ring device.

(A3) In some embodiments of (A2), a second wearable ring device has a second size, distinct from the first size, (e.g., this size can correspond to an International Organization for Standardization (“ISO”) 8653:2016 ring size), and when the second wearable ring device is placed on the top surface of the housing, the first amount of power is received at the second wearable ring device based on power through the transmission of electromagnetic transmitted by the transmitter system to the second wearable ring device (e.g., FIGS. 4A-4C shows charts illustrating that rings of three different sizes still achieve substantially similar coupling efficiencies with the transmitter described herein, thereby enabling various sized wearable ring devices to receive substantially the same amount of power from the transmitter). For example, the first wearable ring device and the second wearable ring device, which are of different sizes, receive substantially the same amount of power despite being placed on the same transmitter device.

(A4) In some embodiments of any of (A1)-(A3), the top surface of the housing includes a circular depression (e.g., such as a circular divot or depression) that has a width that corresponds to the certain thickness of the antenna, or alternatively the largest dimension among the multiple variants of the wearable ring device (e.g., in some embodiments, the width is measured between respective edges of the circular-shaped depression and that width can be the diameter of the circular-shaped depression, which for example is illustrated as outer radiator diameter 208 in FIGS. 2A-2B), and further wherein the circular depression allows for freedom of rotation of the wearable ring device within the circular depression (e.g., so long as the wearable ring device is lying flat then the wearable ring device can be rotated without causing a significant negative impact to the wireless transmission of power to the ring device) while constraining the wearable ring device about a center of the circular depression (e.g., FIG. 1 illustrates that top housing 114 includes a depression 116). In some embodiments, the circular shaped depression has a width that corresponds to the end-to-end width of the antenna

(A5) In some embodiments of (A4), substantially a same amount of power is received at the wearable ring device regardless of rotation of the wearable ring device around/within the circular depression (in other words, the ring can rotate within the circular depression (e.g., in clockwise or counter-clockwise fashion) and the ring continues to receive a same amount of power from the available wirelessly-transmitted power provided by the transmitter). Stated another way, the ring can move in a clockwise or counterclockwise fashion around the depression without impacting the ring's receipt of wireless power (e.g., so long as the wearable ring device is lying flat then the wearable ring device can be rotated without changing the charging efficiency).

(A6) In some embodiments of any of (A1)-(A5), the first inner ring diameter of the smallest wearable ring device is approximately 10 millimeters (or the smallest ISO ring size). In some embodiments, approximately 10 millimeters is 10 millimeters+/−1 millimeter (so between 9-11 millimeters).

(A7) In some embodiments of any of (A1)-(A6), the first outer ring diameter of the largest wearable ring device is approximately 25 millimeters (or an outer diameter of a wearable ring device that has the largest ISO ring size). In some embodiments, approximately 10 millimeters is 10 millimeters+/−1 millimeter (so between 9-11 millimeter)s.

(A8) In some embodiments of any of (A1)-(A7), the inner radiator diameter of the radiator is at least 10 millimeters and outer radiator diameter of the radiator is at most 25 millimeters.

(A9) In some embodiments of any of (A1)-(A8), the antenna is a planar inverted-F antenna (“PIFA”). In some embodiments, the antenna has a gap between the surface of a substrate and the top (or radiating) portion of the antenna, which is illustrated by substrate 216 in FIG. 2A-2B. The antenna within the transmitter system also has a rectangular ground plane as the bottom part.

(A10) In some embodiments of any of (A1)-(A9), at least one of the wearable ring devices (e.g., FIG. 3 shows a housing 302) of the plurality of ring devices includes: a receiver antenna made of a first flexible material (e.g., the receiver antenna is made of material(s) that allows it to be bent and still function as a receiver antenna). In some embodiments, the flexible receiver antenna can be disposed on an exterior surface of the wearable ring device (e.g., FIG. 3 shows a housing 302 that encapsulates a RF receiver antenna 304 that is made of a first flexible material), and a printed circuit board (“PCB”) made of a second flexible material (e.g., the PCB can be bent in a variety of ways and still remain functional), wherein the PCB is coupled to (one of skill in this art will appreciate that the PCB can be coupled to, connected to, or integrated with the various components) the receiver antenna, wherein the PCB includes components for converting RF power (e.g., at least a rectifier that converts RF signals into usable current such as alternating or direct current), received via the receiver antenna, into usable power (e.g., alternating or direct current having a voltage sufficient to power or charge the wearable ring device) (e.g., FIG. 3 illustrates RF receiver antenna 304 that is coupled to PCB 308, which is configured to covert RF electromagnetic waves into usable power).

(A11) In some embodiments of any of (A1)-(A10), the receiver antenna and the PCB, when coupled, are configured to be: (i) placed within an interior of a first wearable ring device (e.g., an interior of the wearable ring device refers to a portion of the wearable ring device that can house the electronic components for the wearable ring device; in some embodiments, the electrical components may be partially visible or hidden from view) for coupling with a first power-storage element of the first wearable ring device the first power-storage element configured to receive the usable power (e.g., FIG. 3 illustrates a PCB 308 and a power storage element 306 that can be placed inside of a wearable ring device), or (ii) placed within an interior of a second wearable ring device, which has a larger size than the first wearable ring device, for coupling with a second power-storage element of the second wearable ring device, the second power-storage element configured to receive the usable power (e.g., FIG. 3 illustrates a PCB 308 and a power storage element 306 that can be placed in a wearable ring device, such as the wearable ring device 204 in FIG. 2A or wearable ring device 212 in FIG. 2B). In other words, there is no need to change the PCB and receiver antenna or the power storage element to allow them to work with wearable rings of different sizes, the PCB, the receiver antenna, and the power storage element can therefore be coupled easily with rings of different sizes to enable those rings to receive wirelessly-delivered power from a transmitter.

(A12) In some embodiments of (A11), the receiver antenna and the PCB are configured to be coupled to one of at least two compatible power-storage elements (e.g., a lithium based battery, a capacitor, or any other suitable storage element) (e.g., PCB 308 in FIG. 3 is coupled to storage element 306), wherein a respective compatible power-storage element of the at least two compatible power-storage elements is also configured to be placed within the interior of the first wearable ring device and the second wearable ring device (e.g., exemplary transparent housing 310 in FIG. 3 shows how the storage element 306 is placed within the interior of a wearable ring device), and each of the PCB, the receiver antenna, and respective compatible power-storage element is radially placed about a circumference of either the first wearable ring device or the second wearable ring device (e.g., exemplary transparent housing 310 in FIG. 3 shows how PCB 308 and RF receiver antenna 304 are placed within the interior of a wearable ring device).

(A13) In some embodiments of (A11), the first wearable ring device and the second wearable ring device each include at least one RF-transparent surface (e.g., a non-conductive material such as plastic or resin) that allows power through the transmission of electromagnetic waves to be received by the receiver antenna.

(A14) In some embodiments of (A11), the first wearable ring device and the second wearable ring device have different inner ring diameters (e.g., first top view 108 and second top view 110 in FIG. 1 show two different wearable ring devices 102 with different inner ring diameters).

(A15) In some embodiments of (A11), the first wearable ring device and the second wearable ring device have different outer ring diameters (e.g., first top view 108 and second top view 110 in FIG. 1 show two different wearable ring devices 102 with different outer ring diameters).

(A16) In some embodiments of (A12), the respective compatible power-storage element has a size that is dependent on the size of either the first wearable ring device or the second wearable ring device. In some embodiments, the size of the storage element can refer to a physical dimension of the battery (volume, shape, weight, etc.) and/or the storage capacity of the battery (e.g., a capacity measured in milliwatt hours). Thus, the PCB and receiver antenna described above (also referred to as a battery module or a wireless-power receiver) can be used to charge storage elements having different characteristics, in addition to working with rings of different sizes.

(A17) In some embodiments of (A11), either the first wearable ring device or the second wearable ring device has an inner ring diameter of approximately 10 millimeters (or the smallest ISO ring size). In some embodiments, approximately 10 millimeters is 10 millimeters+/−1 millimeter (so between 9-11 millimeters).

(A18) In some embodiments of (A11), either the first wearable ring device or the second wearable ring device has an outer ring diameter of approximately 25 millimeters (or an outer diameter of a wearable ring device that has the largest ISO ring size). In some embodiments, approximately is +/−1 millimeter.

(A19) In some embodiments of (A1)-(A10), the receiver antenna follows a meandering path (e.g., RF receiver antenna 304).

(B1) In accordance with some embodiments, a method of manufacturing a transmitter system for wireless power transmission includes providing a housing that includes a top surface and disposing an antenna of the transmitter system inside of the housing and beneath the top surface of the housing so that the antenna is parallel to the top surface of the housing. The top surface allows for placement of one of a plurality of wearable ring devices to be wirelessly charged by the transmitter system, the plurality of wearable ring devices being those wearable ring devices that are capable of receiving wireless power from the transmitter system. The plurality of wearable ring devices include a smallest wearable ring device having a first inner ring diameter that is smaller than or equal to respective inner ring diameters for all other of the plurality of wearable ring devices, and a largest wearable ring device having a first outer ring diameter that is larger than or equal to respective outer ring diameters for all other of the plurality of wearable ring devices. The antenna, placed inside of the housing and beneath the top surface of the housing, is configured to transmit radio frequency (“RF”) electromagnetic waves to the wearable ring device. A radiator of the antenna has a circular shape that is positioned coplanar with the top surface and the radiator has a certain thickness that is defined by an inner radiator diameter and an outer radiator diameter, and the inner radiator diameter of the radiator is substantially equal to the first inner ring diameter of the smallest wearable ring device, and the outer radiator diameter of the radiator is substantially equal to the first outer ring diameter of the largest wearable ring device.

(B2) In some embodiments of (B1), the transmitter system for wireless power transmission is further manufactured to have characteristics in accordance with any of (A1)-(A19).

(C1) In accordance with some embodiments, a method of using a transmitter system to wirelessly transmit power to a wearable ring device of a plurality of ring devices includes placing a respective wearable ring device of a plurality of wearable ring devices on a top surface of a housing. The top surface allows for placement of one of the plurality of wearable ring devices to be wirelessly charged by the transmitter system, the plurality of wearable ring devices being those wearable ring devices that are capable of receiving wireless power from the transmitter system. The plurality of wearable ring devices including a smallest wearable ring device having a first inner ring diameter that is smaller than or equal to respective inner ring diameters for all other of the plurality of wearable ring devices, and a largest wearable ring device having a first outer ring diameter that is larger than or equal to respective outer ring diameters for all other of the plurality of wearable ring devices. In response to the placing the respective wearable ring device is placed on the top surface of the housing, transmitting, via an antenna placed inside of the housing, radio frequency (“RF”) electromagnetic waves to the respective wearable ring device. A radiator of the antenna has a circular shape that is positioned coplanar with the top surface and the radiator has a certain thickness that is defined by an inner radiator diameter and an outer radiator diameter; and the inner radiator diameter of the radiator is substantially equal to the first inner ring diameter of the smallest wearable ring device, and the outer radiator diameter of the radiator is substantially equal to the first outer ring diameter of the largest wearable ring device.

(C2) In some embodiments of (C1), the method also operates using a transmitter system that is configured in accordance with any of (A1)-(A19).

(D1) In accordance with some embodiments, a wearable ring device is configured to receive RF wireless power from the transmitter system of any of claims (A1)-(A19).

(E1) In accordance with some embodiments, an RF power-transmission system comprises the wearable ring device of (D1) and the transmitter system of any of claims (A1)-(A19).

### BRIEF DESCRIPTION OF THE DRAWINGS

So that the present disclosure can be understood in greater detail, a more particular description may be had by reference to the features of various embodiments, some of which are illustrated in the appended drawings. The appended drawings, however, merely illustrate pertinent features of the present disclosure and are therefore not to be considered limiting, for the description may admit to other effective features.

FIG. 1 shows a diagram that displays multiple perspectives of an example embodiment of a near field charging system for charging a wearable ring device, in accordance with some embodiments.

FIG. 2A shows a diagram of an exploded view of the components of a near field charging system for charging a wearable ring device of a first size, in accordance with some embodiments.

FIG. 2B shows a diagram of an exploded view of the components of a near field charging system for charging a wearable ring device of a second size, in accordance with some embodiments.

FIG. 3 shows a diagram of an exploded view of a wearable ring device that includes a wireless-power receiver, in accordance with some embodiments.

FIG. 4A shows a coupling efficiency plot that indicates the power transfer efficiency between the transmitter device and wearable ring devices of different sizes, in accordance with some embodiments.

FIG. 4B shows a coupling efficiency plot that indicates the power transfer efficiency between the transmitter device and wearable ring devices of different sizes, in accordance with some embodiments.

FIG. 4C shows a coupling efficiency plot that indicates the power transfer efficiency between the transmitter device and wearable ring devices of different sizes, in accordance with some embodiments.

FIG. 5 shows a coupling efficiency plot that indicates the power transfer efficiency between the transmitter device and a wearable ring device, where the wearable ring device has been placed at different positions and/or rotations relative to center of the transmitter device, in accordance with some embodiments.

FIG. 6 is a block diagram of an RF wireless-power transmission system, in accordance with some embodiments.

FIG. 7 is a block diagram showing components of an example power transmission system that includes a power transmitter integrated circuit and antenna coverage areas, in accordance with some embodiments.

In accordance with common practice, the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DETAILED DESCRIPTION

Numerous details are described herein in order to provide a thorough understanding of the example embodiments illustrated in the accompanying drawings. However, some embodiments may be practiced without many of the specific details, and the scope of the claims is only limited by those features and aspects specifically recited in the claims. Furthermore, well-known processes, components, and materials have not been described in exhaustive detail so as not to unnecessarily obscure pertinent aspects of the embodiments described herein.

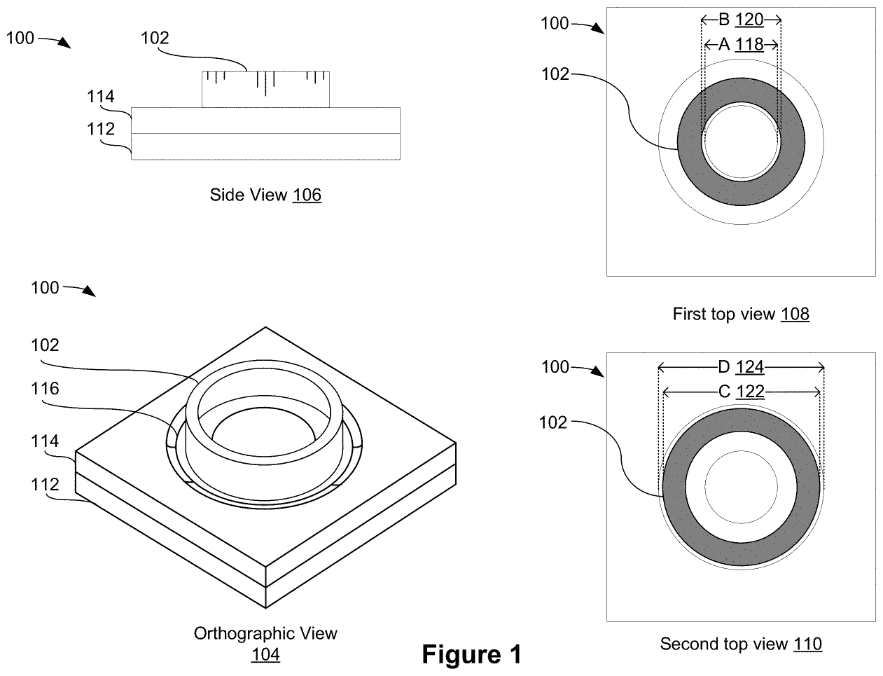

FIG. 1 illustrates side and orthographic views of a representative near-field charging system 100 that is configured to charge a wearable ring devices 102 of varying sizes (e.g., a wearable ring device, for example, can be a smart ring that includes at least one electronic sensor for monitoring data associated with a human user; biometric data and/or data associated with physical activities of the user such as number of steps). The design of a near-field charging system 100 is illustrated in a particular way for ease of illustration and one skilled in the art will appreciate that other designs are possible.

As electronic devices shift to wireless designs (e.g., wearable ring device 102, which in some embodiments is a smart ring) that require them to be charged daily, there has become a need for a convenient way to charge all these devices. Traditional methods have required specialized chargers that are only capable of charging specific ring sizes in specific orientations. Additionally, some traditional methods require designing receiver structures specific to different types and sizes of electronic devices, rather than designing a receiver structure that can be used with a type of electronic device (e.g., smart ring) that can have a number of different sizes. Having a charging surface that can charge wearable ring devices without regard to the orientation of the wearable ring device on the charging surface and the size of the wearable ring devices, similar to the near-field charging system 100 shown in FIG. 1, is highly convenient and reduces production costs, while also ensuring a less frustrating charging experience for ends uses. Because such an approach does not involve individualized chargers based on a specific ring size, the user can simply place the wearable ring device of any supported size they wish to be charged on the charging surface at any position and/or orientation. The user need not perform any additional action to charge the wearable ring device (e.g., the user could just drop the wearable ring device down on the charging surface).

Specifically, FIG. 1 shows views of a representative near-field charging system 100 that wirelessly charges wireless devices (e.g., wearable ring device 102, which in some embodiments is a smart ring) without regard to the orientation of the wireless device on the charging surface and the size of the wearable ring devices. In particular, FIG. 1 shows an orthographic view 104 of a near-field charging system, a side view 106 of a near field charging system, a first top-down view 108 that shows a first wearable ring device of a first size being charged, and a second top-down view 110 that shows a second wearable ring device of a second size (distinct from, and larger than, the first size) being charged.

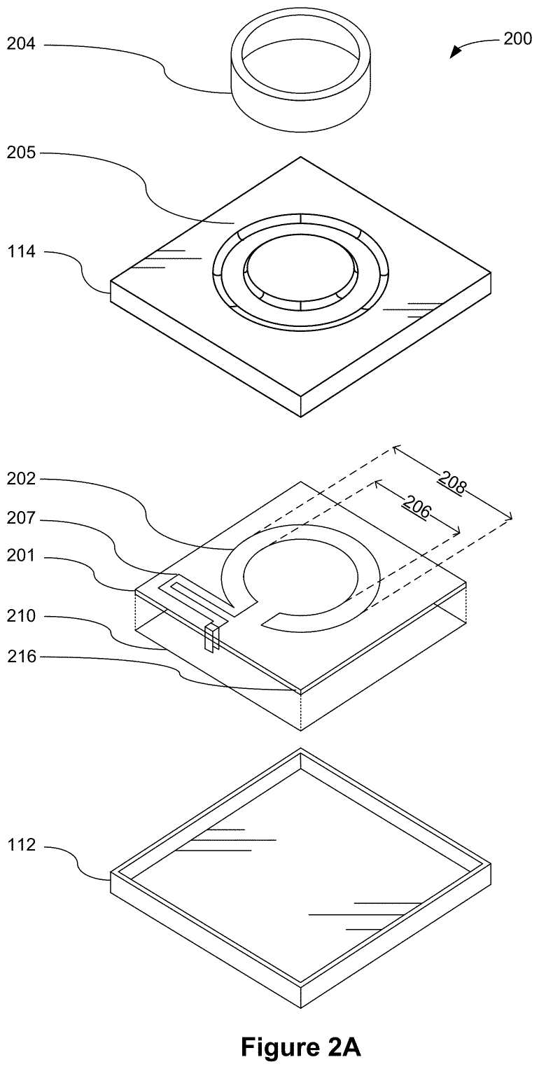

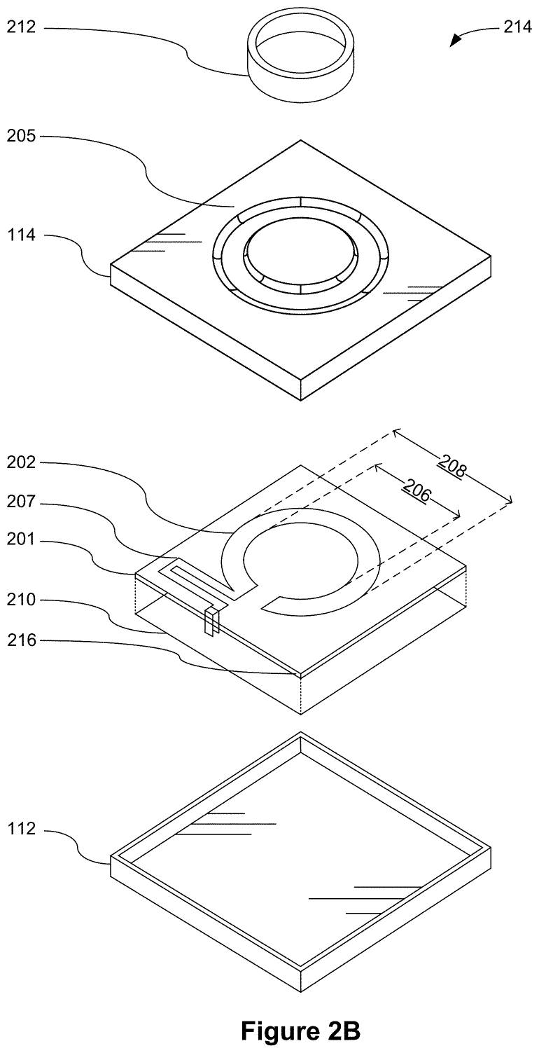

The orthographic view 104 shows a near-field charging system 100. The near field charging system 100 includes a bottom housing 112 and a top housing 114. Encased between these housings are components (described in further detail with respect to FIGS. 2A-2B) for charging the wearable ring device 102. In some embodiments, the top housing 114 defines a depression 116, which aids in orienting wearable ring devices on the top housing 114. The orthographic view 104 also illustrates that the wearable ring device 102 is placed within the depression of a top housing 114. As an added visual aid, side view 106 shows another view of the same near-field charging system 100 shown in the orthographic view 104.

FIG. 1 also shows two top-down views, a first top-down view 108 and a second top-down view 110 to illustrate that the near-field charging system 100 is configured to charge wearable rings of different sizes. In some embodiments, a near-field charging system 100 is configured to charge wearable ring devices that have inner diameters falling between 10 millimeters and 25 millimeters. Alternatively, in some embodiments, a near-field charging system 100 is configured to charge wearable ring devices that have standard US ring sizes (e.g., size 6 to size 13.5) and/or standard UK ring sizes (e.g., size ‘N/2’ to size ‘Z’).

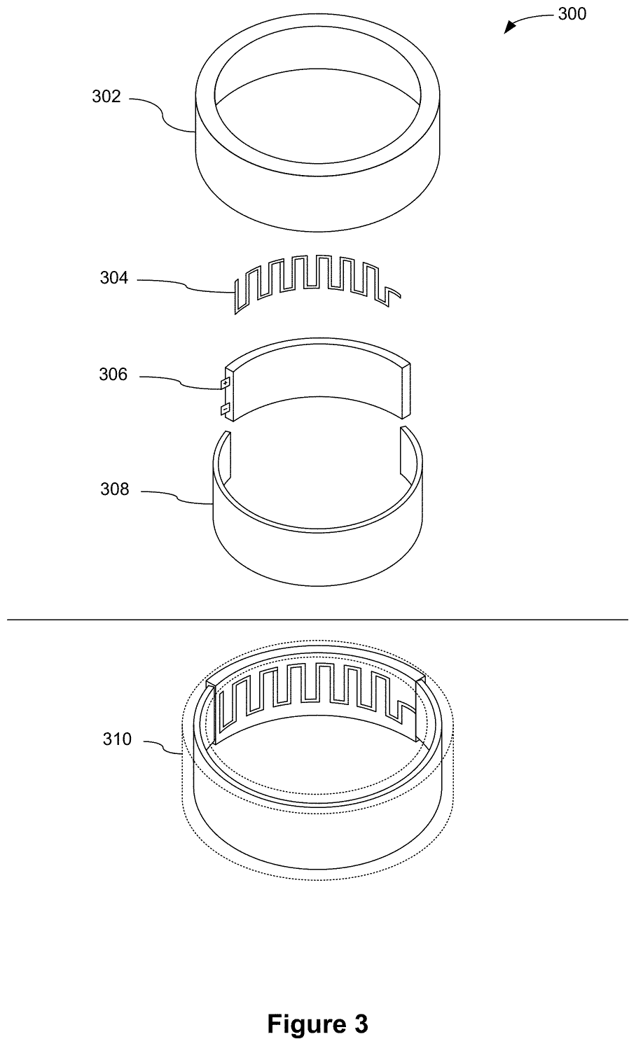

To accommodate all of these wearable ring devices of varying sizes while ensuring adequate charging of each ring device, top housing 114 includes a depression 116 for aligning the ring about a center point of the top housing 114. So long as the wearable ring device 102 fits within the depression at any orientation (i.e., shifted from the center point or any rotation about the center point of the circular depression) the wearable ring device will receive a usable amount of power for powering and/or charging the wearable ring devices battery (discussed in further detail with respect to FIG. 3).

In some embodiments, the inner diameter of the depression 116, indicated by ‘A’ 118 in the first top-down view 108 is undersized by 5% of the smallest supported inner diameter of a wearable ring device, indicated by ‘B’ 120. Conversely, the outer diameter of the depression 116, indicated by ‘C’ 122 in the first top-down view 108 is oversized by 5% of the largest supported outer diameter of a wearable ring device, indicated by ‘D’ 124. In some embodiments, this allows for easier placement of the wearable ring device.

FIG. 2A shows a first exploded view 200 of the near-field charging system 100 described in FIG. 1. Specifically, FIG. 2A illustrates a wearable ring device 204, which corresponds to the wearable ring device 102 in FIG. 1, a top housing 114, and a bottom housing 112. Placed between the top housing 114 and the bottom housing 112 is a transmitter 201, the transmitter 201 including an antenna 207 that includes a radiator 202 configured to output enough Radio Frequency (RF) energy that when the RF energy is rectified by a receiving device (e.g., the wearable ring device) the device will receive a usable amount of power. In some embodiments, usable amount of power is the power required to power or charge the wearable ring device that is in an active state (e.g., the electronic device is operating in a powered-on state, and the device fully charges in a reasonable amount of time (e.g., 1 to 2 hours)). In some embodiments, 100 mW to 200 mW is one example of the usable amount of power discussed above. In some embodiments, the transmitter 201 has a gap between the surface of a substrate 216 and the radiator 202, which is illustrated by the thickness of the transmitter 201.

In some embodiments, the radiator 202 of the antenna 207 includes a circularly-shaped portion that is positioned below and parallel to a top surface 205 of the top housing 114. The radiator 202 has a certain width that is defined between edges of the circularly-shaped portion, such that the certain width is substantially equal to the outer radiator diameter 208. In some embodiments, the radiator 202 is placed 5 mm above the ground plane for the antenna 210. In some embodiments, the transmitter 201 is square-shaped with dimensions of 50.8 mm by 50.8 mm. In some embodiments, the antenna 207 is implemented as a planar inverted F antenna (“PIFA”).

In some embodiments, the inner radiator diameter 206 of the radiator 202 is slightly less than the inner ring diameter of the smallest wearable ring device (e.g., within at least 5% of the inner ring diameter) that can receive a wireless charge from the near-field charging system 100. For example, the smallest wearable ring device may have an inner diameter of 10 mm, but the inner radiator diameter 206 of the radiator 202 would then be about 9.5 mm. In some embodiments, the outer radiator diameter 208 of the radiator 202 is slightly larger than the first outer ring diameter of the largest wearable ring device (e.g., a 25 mm outer ring diameter) that can receive a wireless charge from the near-field charging system 100 (e.g., the outer radiator diameter 208 in the example of a 25 mm outer ring diameter can be approximately 25.5 mm or 26.25 mm). In some embodiments, a 1 mm thick polycarbonate dielectric layer is placed over the radiator or integrated above the PIFA. This polycarbonate layer acts as a protective cover over the bare metal of the radiator, and also provides mechanical support for the top of the radiator. The polycarbonate layer also creates a small gap between the receiver device and the radiator which helps with operation by reducing loading effects. In some embodiments, the polycarbonate layer can be replaced with another layer made of a low loss dielectric material.

FIG. 2B shows a second exploded view 214 of the near-field charging system 100, which is the same exploded view shown in FIG. 2A. This second exploded view 214 highlights that a second wearable ring device 212, which differs in size from the wearable ring device 204, can also be charged by the near-field charging system.

FIG. 3 illustrates an exploded view 300 of the wearable ring device 102. The wearable ring device 102 includes components that enable the wearable ring device 102 to receive power through the transmission of electromagnetic waves, rectify those waves, and store the rectified waves in a power-storage element and/or to directly power various components, such as sensors and/or communication systems of the wearable ring device 102. Specifically, wearable ring device 102 includes a housing 302 that encapsulates a RF receiver antenna 304, a power-storage element 306, and a PCB 308. In some embodiments, wearable ring device 102 also includes various components (e.g., sensors, biometric sensors, and communication systems) that operate using the stored power from the power-storage element.

FIG. 3 also shows an illustrative dashed-line housing 310 that represents the housing 302. In other words, it illustrates how the components are arranged inside the housing 302 when fully assembled. When fully assembled, RF receiver antenna 304 is coupled to PCB 308, and PCB 308 is coupled to power-storage element 306. In some embodiments, there is a gap between the storage element 306 and the receiver antenna 304, and that gap in some embodiments can be in the range of 0.1 mm to 0.5 mm. This gap improves performance of the wearable ring device 102 by not allowing the storage element 306 and the antenna 304 to make contact. In some embodiments, the housing consists of a ring made out of plastic. In some embodiments, a thin metallic coating forming a conductive surface is placed on an outside surface of the housing 302, which aids with charging efficiency. In some embodiments, the metallic coating is used for structural mechanical reasons and/or design reasons. In some embodiments, the thin metallic coating can aid with charging efficiency.

The RF receiver antenna 304 is configured to receive RF signals/waves from the near-field charging system 100. In some embodiments, RF receiver antenna is a monopole antenna that has a shape that meanders (e.g., is a meandered line monopole receiver antenna) as shown in FIG. 3. In some embodiments, receiver antenna 304 can also be an IFA antenna design, a PIFA antenna design, a patch antenna design, or a dipole antenna design. Additionally, the receiver antenna 304 can be made out of a flexible material, which allows the receiver antenna 304 to be placed in housings 302 of different sizes (e.g., housing for different ring sizes). In some embodiments, the overall dimensions of the receiver antenna 304 is 20 mm by 5.7 mm with an overall thickness of 0.085 mm. In some embodiments, the size of the receiver antenna 302 and the PCB 308 both remain constant despite being placed in housings of varying sizes.

The PCB 308 is coupled to the antenna 304 and is configured to convert the received signals from the antenna 308 to usable power (e.g., the PCB includes appropriate rectification circuitry to rectify RF signals into direct current power). In some embodiments, the PCB 308 is made of a flexible material, which allows the PCB 308 to be placed in housings of different sizes. In some embodiments, the overall dimensions of the PCB 308 remain constant despite it being placed in varying sizes of wearable ring devices.

The power-storage element 306 is coupled to the PCB 308 and is configured to store the converted usable power. The power-storage element 306 can be configured to output the usable power to other components in the wearable ring device 102, such as, at least one electronic sensor for monitoring data associated with a human user; biometric data and/or data associated with physical activities of the user such as number of steps, and a communication component (e.g., a Bluetooth or Wi-Fi transmitter/receiver for sending/receiving said data to be displayed within a UI on a connected electronic device that includes a display). The power-storage element in some embodiments can be a chemical-based battery, mechanical storage element, or capacitor type storage element. In some embodiments, the storage element 302 has at least some flexible portions that allow the storage element to be placed in housings of different sizes (e.g., sizes based on ring sizes). In some embodiments, storage element 306 may be varied in size (e.g., storage capacity and/or layout configuration) based on the size of the wearable ring device 102.

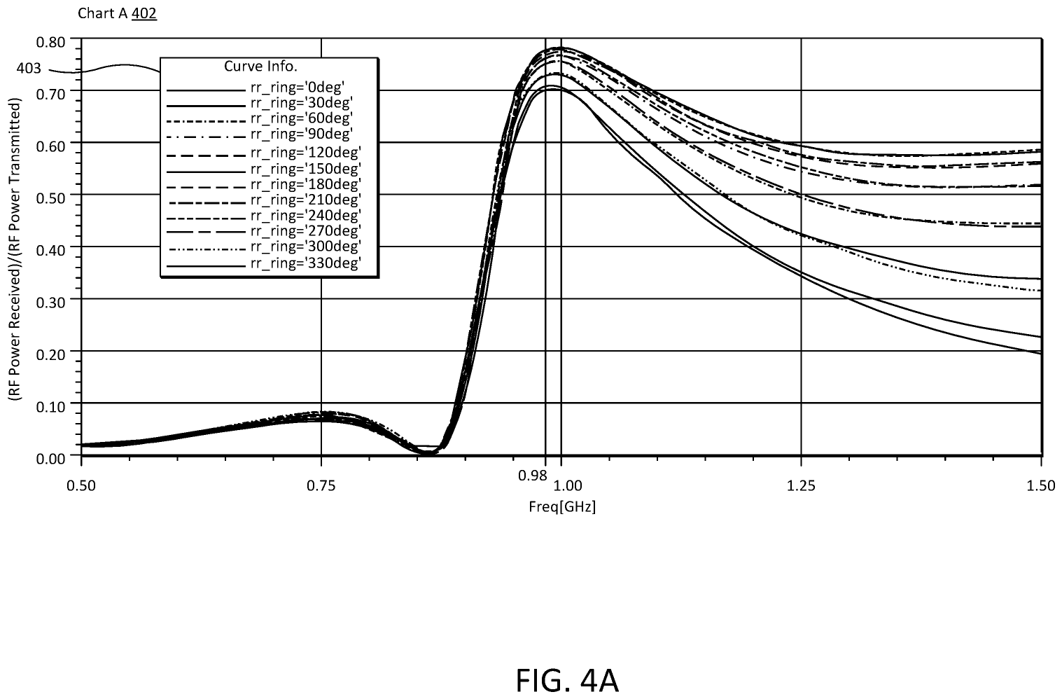

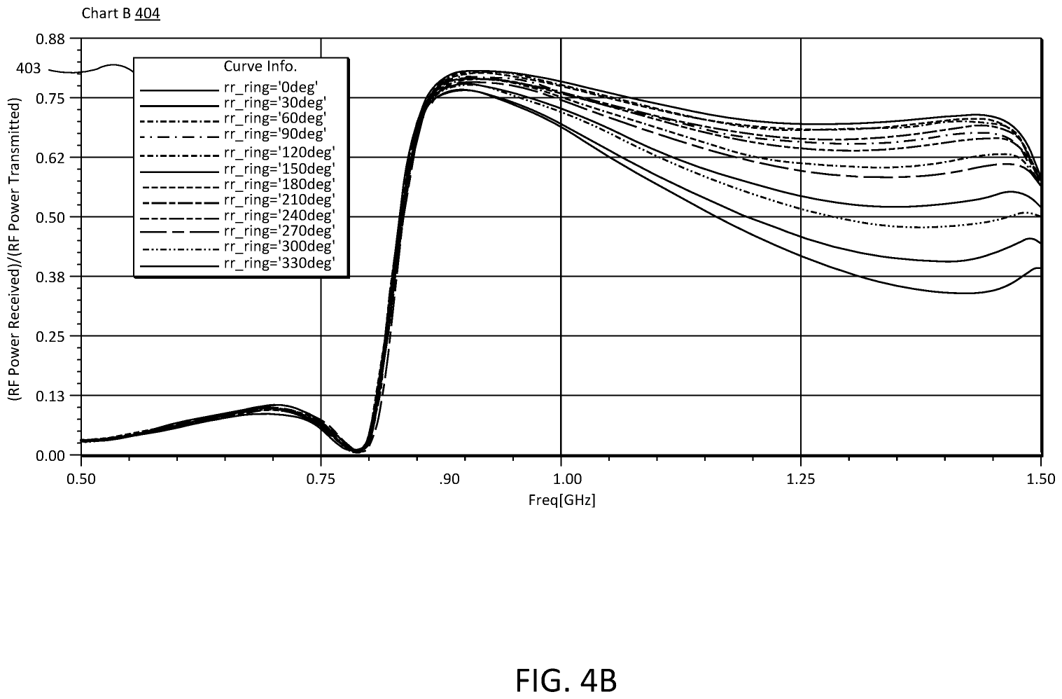

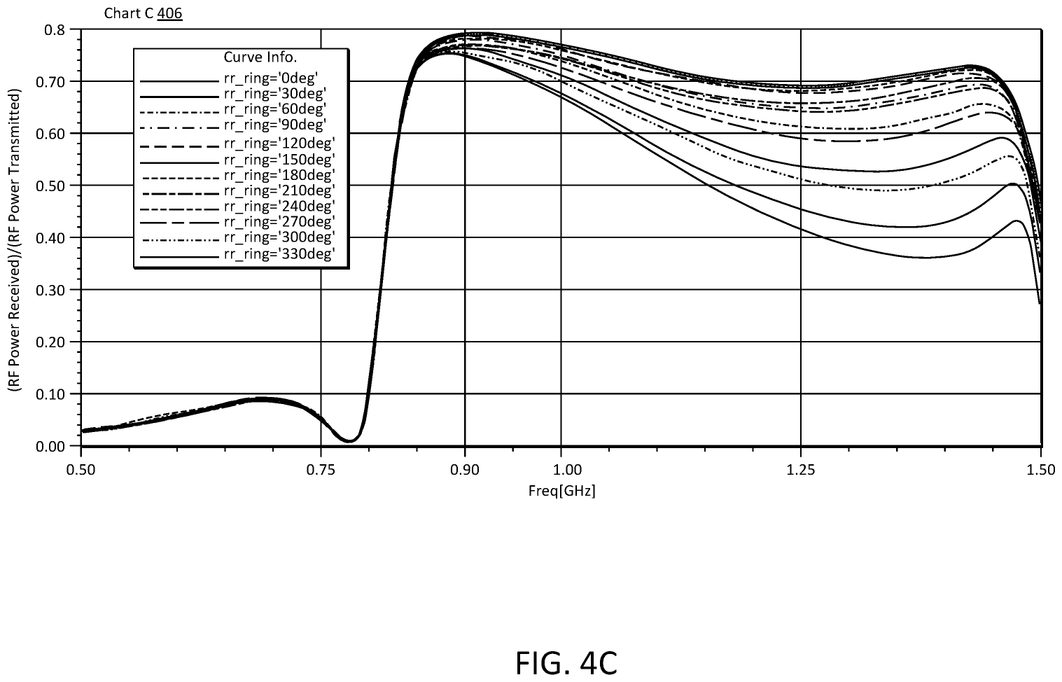

FIG. 4A-4C shows each illustrate a plots, each of which illustrate coupling efficiency associated with the transfer of power within the near-field charging system 100 (e.g., from the transmitter 100 to a receiving device (e.g., the wearable ring device 102)).

In particular, “Chart A” 402 in FIG. 4A shows the power transfer efficiency or coupling efficiency for wearable ring device with a first size (e.g., an International Organization for Standardization (“ISO”) 8653:2016 ring size of six). The chart also shows how the coupling efficiency remains largely the same despite the wearable ring device of the first size being rotated to different positions with respect within depression 116 of the transmitter 100 (FIG. 1). Each one of the lines plotted in “Chart A” 402 represent the wearable ring device being rotated a defined degree amount (e.g., “Chart A” 402 shows the coupling efficiency of a wearable ring device at various rotations. These rotations (identified by “rr_ring”) are indicated in the legend 403, which shows the coupling efficiency at 0 degrees, 30 degrees, 60 degrees, 90 degrees, 120 degrees, 150 degrees, 180 degrees, 210 degrees, 240 degrees, 270 degrees, 300 degrees, 330 degrees). The order of the lines in the legend 403 from top to bottom of the legend corresponds to the order of lines found in “Chart A” 402 from top to bottom of the chart. In fact, “Chart A” 402 shows that at 900 MHz the coupling efficiency is between 0.71 and 0.74 at any degree of rotation. In other words, the coupling efficiency remains largely the same at specified frequency regardless of the position that the ring is in within the depression 116.

“Chart B” 404 shown in FIG. 4B and “Chart C” 406 shown in FIG. 4C are shown in conjunction with “Chart A” 402 in FIG. 4A to illustrate that the coupling efficiency remains, again, largely the same across varying sizes of wearable ring devices. For example, in “Chart B” 404 a wearable ring device with a second size (e.g., an ISO size 10 ring) has a coupling efficiency between 0.77 and 0.8, which is similar to the coupling efficiencies for a first wearable ring device discussed in reference to “Chart A” 402. “Chart C” 406 demonstrates that a wearable ring device with a third size (e.g., an ISO size 13 ring) has a coupling efficiency between 0.75 and 0.79, which is similar to the coupling efficiencies for a first wearable ring device discussed in reference to “Chart A” 402 and a second wearable ring device discussed in reference to “Chart B” 404.

In summary, at a specified frequency (e.g., 900 MHz in this one example, although the same beneficial results can be obtained at other frequencies as well, such as at 2.4 or 4.8 GHz) the coupling efficiency (e.g., the power received divided by the power transmitted) within a near-field charging system 100 to wirelessly deliver power to a wearable ring device 102 remains substantially constant irrespective of the size of the wearable ring device 102 and its radial orientation within depression 116 (depicted in FIG. 1).

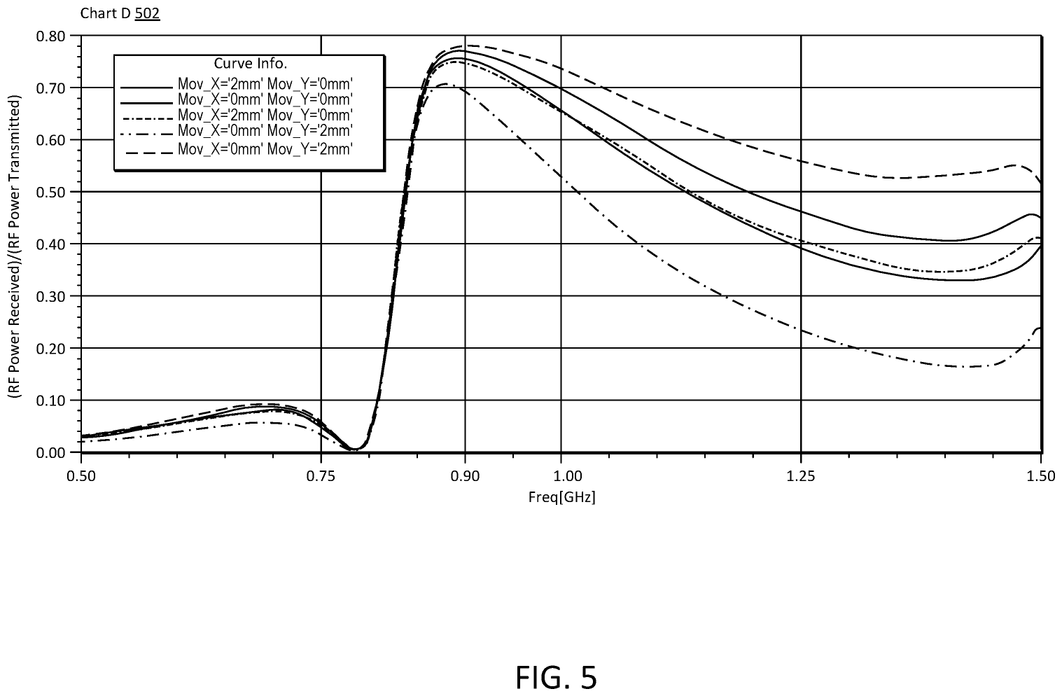

FIG. 5, shows an additional chart, “Chart D” 502, that highlights the coupling efficiency within a near-field charging system 100 to wirelessly deliver power to a wearable ring device 102 when the wearable ring device 102 is offset from the center point of a charging area of the near-field charging system 100 (e.g., the wearable ring device 102 is offset by some distance in the X-direction and/or the Y-direction from the center point of the top housing 114 (e.g., an offset distance that still allows the wearable ring device 102 to be placed on the top housing 114)). In particular, FIG. 5 shows that the power transfer efficiency or coupling efficiency for an ISO size 10 wearable ring device at various shifted orientations (e.g., offsets from the center point of the transmitter's primary charging area) with respect to the near-field charging system 100. The legend 504 of FIG. 5 recites “Mov_X” and “Mov_Y,” which specifies the movement, in millimeters, of wearable ring device 102 from center of the near-field charging system 100 in the X-Y plane. In particular the legend 504 shows the coupling efficiency at offsets of: Mov_X=−2 mm and Mov_Y=0 mm, Mov_X=0 mm and Mov_Y=0 mm, Mov_X=2 mm and Mov_Y=0 mm, Mov_X=0 mm and Mov_Y=−2 mm, and Mov_X=0 mm and Mov_Y=2 mm.

Allowing for varying ring sizes and placements of the wearable ring device at different orientations allows a user to easily place their wearable ring device 102 on the near field charging system 100 without the need to fumble with orientation or have to worry about charging speed or size compatibility.

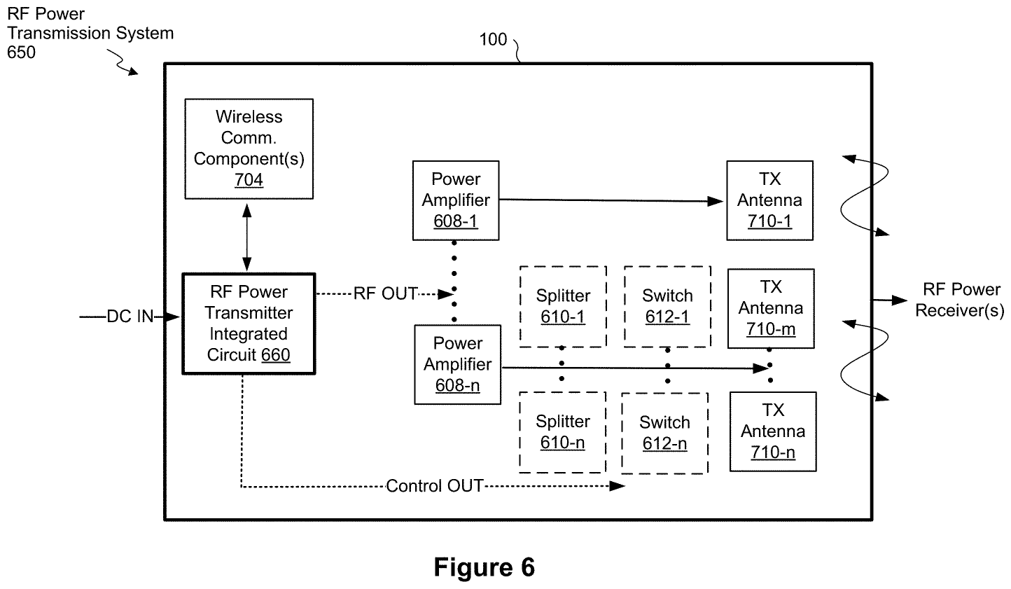

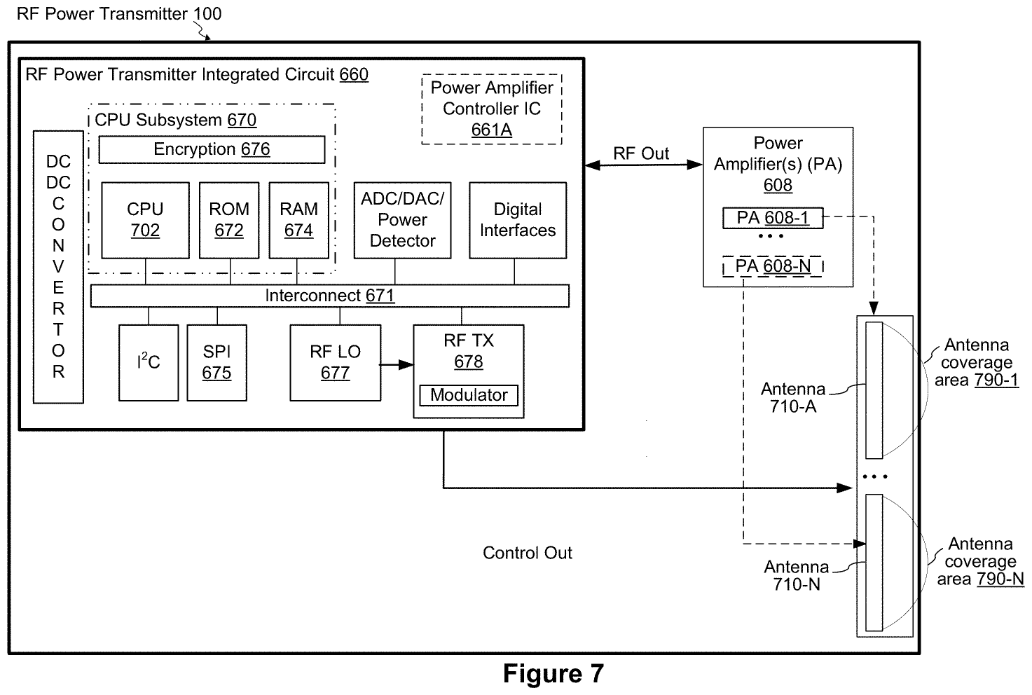

While the above descriptions focused on the near-field charging system 100 and the wearable ring device 102, these descriptions are for illustrative purposes, and one of skill in the art will also appreciate that additional components are used to safely control the transmission of wireless power by the near-field charging system 100. For instance, additional components of the near-field charging system 100 and the wearable ring device 102 are shown in the system block diagrams of FIGS. 6 and 7.

FIG. 6 is a block diagram of an RF wireless-power transmission system 650 in accordance with some embodiments. In some embodiments, the RF wireless-power transmission system 650 includes an RF power transmitter 100 (also referred to herein as a near-field (NF) charging system 100), NF power transmitter 100, RF power transmitter 100). In some embodiments, the RF power transmitter 100 includes an RF power transmitter integrated circuit 660 (described in more detail below). In some embodiments, the RF power transmitter 100 includes one or more communications components 704 (e.g., wireless communication components, such as WI-FI or BLUETOOTH radios). In some embodiments, the RF power transmitter 100 also connects to one or more power amplifier units 608-1, . . . 608-n to control operation of the one or more power amplifier units when they drive at least one external power-transfer elements (e.g., power-transfer elements, such as transmission antennas 710-1 to 710-n). In some embodiments, a single power amplifier, e.g. 608-1 is controlling one antenna 710-1. In some embodiments, power sent through the transmission of electromagnetic waves is controlled and modulated at the RF power transmitter 100 via switch circuitry as to enable the RF wireless-power transmission system to send electromagnetic waves to one or more wireless receiving devices via the TX antenna array 710. In some embodiments, a single power amplifier, e.g. 608-n is controlling multiple antennas 710-m to 710-n through multiple splitters (610-1 to 610-n) and multiple switches (612-1 to 612-n).

In some embodiments, the communication component(s) 704 enable communication between the RF power transmitter 100 and one or more communication networks. In some embodiments, the communication component(s) 704 are capable of data communications using any of a variety of custom or standard wireless protocols (e.g., IEEE 802.15.4, Wi-Fi, ZigBee, 6LoWPAN, Thread, Z-Wave, Bluetooth Smart, ISA100.11a, WirelessHART, MiWi, etc.) custom or standard wired protocols (e.g., Ethernet, HomePlug, etc.), and/or any other suitable communication protocol, including communication protocols not yet developed as of the filing date of this document. In some instances, the communication component(s) 704 are not able to communicate with wireless-power receivers for various reasons, e.g., because there is no power available for the communication component(s) to use for the transmission of data signals or because the wireless-power receiver itself does not actually include any communication component of its own. As such, in some optional embodiments, near-field power transmitters described herein are still able to uniquely identify different types of devices and, when a wireless-power receiver is detected, figure out if that wireless-power receiver is authorized to receive wireless-power. In some embodiments, a signature-signal receiving/generating circuits are used in identifying the receivers as described in more detail below and are also described in U.S. patent application Ser. No. 16/045,637, “Systems and Methods for Detecting Wireless Power Receivers and Other Objects at a Near-Field Charging Pad,” filed on Jul. 25, 2018, which is hereby incorporated by reference in its entirety.

FIG. 7 is a block diagram of the RF power transmitter integrated circuit 660 (the “RF IC”) in accordance with some embodiments. In some embodiments, the RF IC 660 includes a CPU subsystem 670, an external device control interface, an RF subsection for DC to RF conversion, and analog and digital control interfaces interconnected via an interconnection component, such as a bus or interconnection fabric block 671. In some embodiments, the CPU subsystem 670 includes a microprocessor unit (CPU) 702 with related Read-Only-Memory (ROM) 672 for device program booting via a digital control interface, e.g. an I2C port, to an external FLASH containing the CPU executable code to be loaded into the CPU Subsystem Random Access Memory (RAM) 674 or executed directly from FLASH. In some embodiments, the CPU subsystem 670 also includes an encryption module or block 676 to authenticate and secure communication exchanges with external devices, such as wireless-power receivers that attempt to receive wirelessly delivered power from the RF power transmitter 100.

In some embodiments, the RF IC 660 also includes (or is in communication with) a power amplifier controller IC 661A (PA IC) that is responsible for controlling and managing operations of a power amplifier, including for reading measurements of impedance at various measurement points within the power amplifier. The PA IC 661A may be on the same integrated circuit at the RF IC 660, or may be on its own integrated circuit that is separate from (but still in communication with) the RF IC 660. In some embodiments, the PA IC 661A is on the same chip with one or more of the Power Amplifiers (PAs) 608. In some other embodiments, the PA IC 661A is on its own chip that is a separate chip from the Power Amplifiers (PAs) 608.

In some embodiments, executable instructions running on the CPU are used to manage operation of the RF power transmitter 100 and to control external devices through a control interface, e.g., SPI control interface 675, and the other analog and digital interfaces included in the RF power transmitter integrated circuit 660. In some embodiments, the CPU subsystem 670 also manages operation of the RF subsection of the RF power transmitter integrated circuit 660, which includes an RF local oscillator (LO) 677 and an RF transmitter (TX) 678. In some embodiments, the RF LO 677 is adjusted based on instructions from the CPU subsystem 670 and is thereby set to different desired frequencies of operation, while the RF TX converts, amplifies, modulates the RF output as desired to generate a viable RF power level.

In some embodiments, the RF power transmitter integrated circuit 660 provides the viable RF power level (e.g., via the RF TX 678) directly to the one or more power amplifiers 608 and does not use any beam-forming capabilities (e.g., bypasses/disables a beam-forming IC and/or any associated algorithms if phase-shifting is not required, such as when only a single antenna 710 is used to transmit power transmission signals to a wireless-power receiver). In some embodiments, the PA IC 661A regulates the functionality of the PAs 608 including adjusting the viable RF power level to the PAs 608.

In some embodiments, the RF power transmitter integrated circuit 660 provides the viable RF power level (e.g., via the RF TX 678) directly to the one or more power amplifiers 608 and does not use a beam-forming IC. In some embodiments, by not using beam-forming control, there is no active beam-forming control in the power transmission system. For example, in some embodiments, by eliminating the active beam-forming control, the relative phases of the power signals from different antennas are unaltered after transmission. In some embodiments, by eliminating the active beam-forming control, the phases of the power signals are not controlled and remain in a fixed or initial phase. In some embodiments, the PA IC 661A regulates the functionality of the PAs 608 including adjusting the viable RF power level to the PAs 608.

FIG. 8 shows a flow diagram of a method of constructing a near-field charging system, in accordance with some embodiments. In some embodiments, the method of FIG. 8 is performed by a manufacturer of near-field charging systems, or by a manufacturer of components such systems.

Safety Techniques

To ensure a safe transmission of power, additional techniques can also be utilized with the wireless charging systems described herein. A few example techniques are discussed below.

A transmitter can determine the present SAR value of RF energy at one or more particular locations of the transmission field using one or more sampling or measurement techniques. In some embodiments, the SAR values within the transmission field are measured and pre-determined by SAR value measurement equipment. In some implementations, the transmitter may be preloaded with values, tables, and/or algorithms that indicate for the transmitter which distance ranges in the transmission field are likely to exceed to a pre-stored SAR threshold value. In some implementations, the transmitter may be preloaded with values, tables, and/or algorithms that indicate for the transmitter which radiation profiles within the transmission field are likely to exceed to a pre-stored SAR threshold value. For example, a lookup table may indicate that the SAR value for a volume of space (V) located some distance (D) from the transmitter receiving a number of power waves (P) having a particular frequency (F). One skilled in the art, upon reading the present disclosure, will appreciate that there are any number of potential calculations, which may use any number of variables, to determine the SAR value of RF energy at a particular locations, each of which is within the scope of this disclosure.

Moreover, a transmitter may apply the SAR values identified for particular locations in various ways when generating, transmitting, or adjusting the radiation profile. An SAR value at or below 1.6 W/kg, is in compliance with the FCC (Federal Communications Commission) SAR requirement in the United States. A SAR value at or below 2 W/kg is in compliance with the IEC (International Electrotechnical Commission) SAR requirement in the European Union. In some embodiments, the SAR values may be measured and used by the transmitter to maintain a constant energy level throughout the transmission field, where the energy level is both safely below a SAR threshold value but still contains enough RF energy for the receivers to effectively convert into electrical power that is sufficient to power an associated device, and/or charge a battery. In some embodiments, the transmitter may proactively modulate the radiation profiles based upon the energy expected to result from newly formed radiation profiles based upon the predetermined SAR threshold values. For example, after determining how to generate or adjust the radiation profiles, but prior to actually transmitting the power, the transmitter may determine whether the radiation profiles to be generated will result in RF energy accumulation at a particular location that either satisfies or fails the SAR threshold. Additionally or alternatively, in some embodiments, the transmitter may actively monitor the transmission field to reactively adjust power waves transmitted to or through a particular location when the transmitter determines that the power waves passing through or accumulating at the particular location fail the SAR threshold. Where the transmitter is configured to proactively and reactively adjust the power radiation profile, with the goal of maintaining a continuous power level throughout the transmission field, the transmitter may be configured to proactively adjust the power radiation profile to be transmitted to a particular location to be certain the power waves will satisfy the SAR threshold, but may also continuously poll the SAR values at locations throughout the transmission field (e.g., using one or more sensors configured to measure such SAR values) to determine whether the SAR values for power waves accumulating at or passing through particular locations unexpectedly fail the SAR threshold.

In some embodiments, control systems of transmitters adhere to electromagnetic field (EMF) exposure protection standards for human subjects. Maximum exposure limits are defined by US and European standards in terms of power density limits and electric field limits (as well as magnetic field limits). These include, for example, limits established by the Federal Communications Commission (FCC) for MPE, and limits established by European regulators for radiation exposure. Limits established by the FCC for MPE are codified at 47 CFR § 1.1310. For electromagnetic field (EMF) frequencies in the microwave range, power density can be used to express an intensity of exposure. Power density is defined as power per unit area. For example, power density can be commonly expressed in terms of watts per square meter (W/m2), milliwatts per square centimeter (mW/cm2), or microwatts per square centimeter (μW/cm2).

In some embodiments, and as a non-limiting example, the wireless-power transmission systems disclosed herein comply with FCC Part § 18.107 requirement which specifies “Industrial, scientific, and medical (ISM) equipment. Equipment or appliances designed to generate and use locally RF energy for industrial, scientific, medical, domestic or similar purposes, excluding applications in the field of telecommunication.” In some embodiments, the wireless-power transmission systems disclosed herein comply with ITU (International Telecommunication Union) Radio Regulations which specifies “industrial, scientific and medical (ISM) applications (of radio frequency energy): Operation of equipment or appliances designed to generate and use locally radio frequency energy for industrial, scientific, medical, domestic or similar purposes, excluding applications in the field of telecommunications.” In some embodiments, the wireless-power transmission systems disclosed herein comply with other requirements such as requirements codified under EN 62311: 2008, IEC/EN 662209-2: 2010, and IEC/EN 62479: 2010.

In some embodiments, the present systems and methods for wireless-power transmission incorporate various safety techniques to ensure that human occupants in or near a transmission field are not exposed to EMF energy near or above regulatory limits or other nominal limits. One safety method is to include a margin of error (e.g., about 10% to 20%) beyond the nominal limits, so that human subjects are not exposed to power levels at or near the EMF exposure limits. A second safety method can provide staged protection measures, such as reduction or termination of wireless-power transmission if humans (and in some embodiments, other living beings or sensitive objects) move toward a radiation area with power density levels exceeding EMF exposure limits. In some embodiments, these safety methods (and others) are programmed into a memory of the transmitter (e.g., memory 706) to allow the transmitter to execute such programs and implement these safety methods. In some embodiments, the safety methods are implemented by using sensors to detect a foreign object within the transmission field.

The preceding description of the disclosed embodiments is provided to enable any person skilled in the art to make or use the embodiments described herein and variations thereof. Various modifications to these embodiments will be readily apparent to those skilled in the art, and the generic principles defined herein may be applied to other embodiments without departing from the spirit or scope of the subject matter disclosed herein. Thus, the present disclosure is not intended to be limited to the embodiments shown herein but is to be accorded the widest scope consistent with the following claims and the principles and novel features disclosed herein.

Features of the present invention can be implemented in, using, or with the assistance of a computer program product, such as a storage medium (media) or computer readable storage medium (media) having instructions stored thereon/n which can be used to program a processing system to perform any of the features presented herein. The storage medium (e.g., memory 206, 256) can include, but is not limited to, high-speed random-access memory, such as DRAM, SRAM, DDR RAM or other random-access solid-state memory devices, and may include non-volatile memory, such as one or more magnetic disk storage devices, optical disk storage devices, flash memory devices, or other non-volatile solid state storage devices. Memory optionally includes one or more storage devices remotely located from the CPU(s) (e.g., processor(s)). Memory, or alternatively the non-volatile memory device(s) within the memory, comprises a non-transitory computer readable storage medium.

Stored on any one of the machine readable medium (media), features of the present invention can be incorporated in software and/or firmware for controlling the hardware of a processing system (such as the components associated with the transmitters 100 and/or receivers 104), and for enabling a processing system to interact with other mechanisms utilizing the results of the present invention. Such software or firmware may include, but is not limited to, application code, device drivers, operating systems, and execution environments/containers.

It will be understood that, although the terms “first,” “second,” etc. may be used herein to describe various elements, these elements should not be limited by these terms. These terms are only used to distinguish one element from another.

The terminology used herein is for the purpose of describing particular embodiments only and is not intended to be limiting of the claims. As used in the description of the embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

The foregoing description, for purpose of explanation, has been described with reference to specific embodiments. However, the illustrative discussions above are not intended to be exhaustive or to limit the claims to the precise forms disclosed. Many modifications and variations are possible in view of the above teachings. The embodiments were chosen and described in order to best explain principles of operation and practical applications, to thereby enable others skilled in the art.

What is claimed is:

1. A transmitter system for wireless power transmission, the system comprising:
a housing that includes a top surface that allows for placement of one of a plurality of wearable ring devices to be wirelessly charged by the transmitter system, the plurality of wearable ring devices being those wearable ring devices that are capable of receiving wireless power from the transmitter system, the plurality of wearable ring devices including:
a smallest wearable ring device having a first inner ring diameter that is smaller than or equal to respective inner ring diameters for all other of the plurality of wearable ring devices;
a largest wearable ring device having a first outer ring diameter that is larger than or equal to respective outer ring diameters for all other of the plurality of wearable ring devices;
an antenna, placed inside of the housing and disposed below the top surface, configured to transmit radio frequency (“RF”) electromagnetic waves to the wearable ring device, wherein:
(i) a radiator of the antenna has a circular shape that is positioned coplanar with the top surface and the radiator has a certain thickness that is defined by an inner radiator diameter and an outer radiator diameter; and
(ii) the inner radiator diameter of the radiator is substantially equal to the first inner ring diameter of the smallest wearable ring device, and the outer radiator diameter of the radiator is substantially equal to the first outer ring diameter of the largest wearable ring device;
the transmitter system is further configured to: determine whether a respective wearable ring device of the plurality of wearable ring devices is placed on the top surface of the housing; and
in response to determining that the respective wearable ring device is placed on the top surface of the housing, the transmitter system is configured to transmit RF electromagnetic waves to the respective wearable ring device.

2. The transmitter system of claim 1, wherein a first wearable ring device has a first size, and when the first wearable ring device is placed on the top surface of the housing, a first amount of power is received at the first wearable ring device based on RF electromagnetic waves transmitted by the transmitter system to the first wearable ring device

3. The transmitter system of claim 2, wherein a second wearable ring device has a second size, distinct from the first size, and when the second wearable ring device is placed on the top surface of the housing, the first amount of power is received at the second wearable ring device based on RF electromagnetic waves transmitted by the transmitter system to the first wearable ring device.

4. The transmitter system of claim 1, wherein the top surface of the housing includes a circular depression that has a width that corresponds to the certain thickness of the antenna, and further wherein the circular depression allows for freedom of rotation of a wearable ring device of the plurality of wearable ring devices around the circular depression while constraining the wearable ring device about a center of the circular depression.

5. The transmitter system of claim 4, wherein substantially a same amount of power is received at the wearable ring device of the plurality of wearable ring devices regardless of rotation of the wearable ring device about the center of the circular depression

6. The transmitter system of claim 1, wherein the first inner ring diameter of the smallest wearable ring device is approximately 10 millimeters.

7. The transmitter system of claim 1, wherein the first outer ring diameter of the largest wearable ring device is approximately 25 millimeters.

8. The transmitter system of claim 1, wherein the antenna is a planar inverted-F antenna (“PIFA”).

9. The transmitter system of claim 1, wherein at least one of the wearable ring devices of the plurality of wearable ring devices includes:
a receiver antenna made of a first flexible material; and
a printed circuit board (“PCB”) made of a second flexible material, wherein the PCB is coupled to the receiver antenna, wherein the PCB includes components for converting RF electromagnetic waves, received via the receiver antenna, into usable power.

10. The transmitter system of claim 9, wherein the receiver antenna and the PCB, when coupled, are configured to be:
(i) placed within an interior of a first wearable ring device for coupling with a first power-storage element of the first wearable ring device, the first power-storage element configured to receive the usable power; or
(ii) placed within an interior of a second wearable ring device, which has a larger diameter than the first wearable ring device, for coupling with a second power-storage element of the second wearable ring device, the second power-storage element configured to receive the usable power.

11. The transmitter system of claim 10, wherein each of the PCB, the receiver antenna, and the first power-storage element or second power-storage element are radially placed about a circumference of either the first wearable ring device or the second wearable ring device.

12. The transmitter system of claim 11, wherein the first power-storage element or second power-storage element has a size that is dependent on the size of either the first wearable ring device or the second wearable ring device.

13. The transmitter system of claim 10, wherein the first wearable ring device and the second wearable ring device each include at least one RF-transparent surface that allows RF electromagnetic waves to be received by the receiver antenna.

14. The transmitter system of claim 10, wherein the first wearable ring device and the second wearable ring device have different inner ring diameters.

15. The transmitter system of claim 10, wherein the first wearable ring device and the second wearable ring device have different outer ring diameters.

16. The transmitter system of claim 10, wherein either the first wearable ring device or the second wearable ring device has an inner ring diameter of approximately 10 millimeters.

17. The transmitter system of claim 10, wherein either the first wearable ring device or the second wearable ring device has an outer ring diameter of approximately 25 millimeters.

18. The transmitter system of claim 9, wherein the receiver antenna follows a meandering path.

19. A method of manufacturing a transmitter system for wireless power transmission, the method including:
providing a housing that includes a top surface; and
disposing an antenna of the transmitter system inside of the housing and beneath the top surface of the housing so that the antenna is parallel to the top surface of the housing, wherein:
the top surface allows for placement of one of a plurality of wearable ring devices to be wirelessly charged by the transmitter system, the plurality of wearable ring devices being those wearable ring devices that are capable of receiving wireless power from the transmitter system, the plurality of wearable ring devices including:
a smallest wearable ring device having a first inner ring diameter that is smaller than or equal to respective inner ring diameters for all other of the plurality of wearable ring devices, and
a largest wearable ring device having a first outer ring diameter that is larger than or equal to respective outer ring diameters for all other of the plurality of wearable ring devices, and
the antenna, placed inside of the housing and beneath the top surface of the housing, is configured to transmit radio frequency (“RF”) electromagnetic waves to the wearable ring device, wherein:
(i) a radiator of the antenna has a circular shape that is positioned coplanar with the top surface and the radiator has a certain thickness that is defined by an inner radiator diameter and an outer radiator diameter; and
(ii) the inner radiator diameter of the radiator is substantially equal to the first inner ring diameter of the smallest wearable ring device, and the outer radiator diameter of the radiator is substantially equal to the first outer ring diameter of the largest wearable ring device.

20. A method of using a transmitter system to wirelessly transmit power to a wearable ring device of a plurality of ring devices, the method including:
placing a respective wearable ring device of a plurality of wearable ring devices on a top surface of a housing, wherein:
the top surface allows for placement of one of the plurality of wearable ring devices to be wirelessly charged by the transmitter system, the plurality of wearable ring devices being those wearable ring devices that are capable of receiving wireless power from the transmitter system, the plurality of wearable ring devices including:
a smallest wearable ring device having a first inner ring diameter that is smaller than or equal to respective inner ring diameters for all other of the plurality of wearable ring devices, and
a largest wearable ring device having a first outer ring diameter that is larger than or equal to respective outer ring diameters for all other of the plurality of wearable ring devices; and
in response to the placing the respective wearable ring device is placed on the top surface of the housing, transmitting, via an antenna placed inside of the housing, radio frequency (“RF”) electromagnetic waves to the respective wearable ring device, wherein:
(i) a radiator of the antenna has a circular shape that is positioned coplanar with the top surface and the radiator has a certain thickness that is defined by an inner radiator diameter and an outer radiator diameter; and
(ii) the inner radiator diameter of the radiator is substantially equal to the first inner ring diameter of the smallest wearable ring device, and the outer radiator diameter of the radiator is substantially equal to the first outer ring diameter of the largest wearable ring device.
